(19) United States
(12) Patent Application Publication
(10) Pub. No.: US 2009/0090528 A1
(43) Pub. Date: Apr. 9, 2009

(54) Hand-held power tool with vibration-compensating mass

(75) Inventors: Erwin Manschitz, Germering (DE); Franz Popp, Buchloe (DE); Franz Moessnang, Landsberg (DE)

Correspondence Address: ABELMAN, FRAYNE & SCHWAB, 666 THIRD AVENUE, 10TH FLOOR, NEW YORK, NY, 10017, US

(73) Assignee: Hilti Aktiengesellschaft

(21) Appl. No.: 12/284,650

(22) Filed: Sep. 23, 2008

(30) Foreign Application Priority Data
Oct. 9, 2007 (DE) 10 2007 000 837.8

(51) Int. Cl. B25D 17/24; B25F 5/00

(52) U.S. Cl. 173/162.1

(57) ABSTRACT

A hand-held power tool includes a vibration-compensating mass (3, 3′) secured on the tool housing and having at least one rigid compensation mass (4, 4′, 4″) oscillating along an oscillation axis (A), formed of a plurality of fixedly connected with each other mass components (12, 12′, 12″), and supported relative to the housing (2), by at least one spring (5).

### BACKGROUND OF THE INVENTION

1. Field of the Invention

The present invention relates to a hand-held power tool having a percussion mechanism, in particular, to a hammer drill, combination hammer, or chisel hammer.

2. Description of the Prior Art

In hand-held power tools, which applies axial blows to a working tool, particular housing vibrations should be prevented from acting on the power tool handle. Due to the axial mirror symmetry of conventional hand-held power tools, these vibrations primarily take place within a vibration plane in the axial direction and along the guide handle.

A vibration-compensating mass is a vibration-capable system that consists of an abstract vibrating mass, an abstract spring, and an abstract damper which, respectively, need not be formed as concrete components, but can be practically realized as constantly occurring friction and flow losses. One distinguishes between conventional passive vibration-compensation masses which are exclusively excited automatically and actively controlled vibration-compensating masses which are purposefully independently excited by a primarily periodic, excitation function.

By suitable selection of the spring constant and mass, with a passive vibration-compensating mass, its natural frequency is dimensioned according to the to-be-damped interference frequency, in this case, to the vibration of the outer housing of the hand-held power tool.

French Publication FR 2237734 discloses use of a passive vibration-compensating mass for preventing housing vibrations in a percussion hand-held power tool.

German Patent DE 815 179 discloses arrangement of two axially oscillating passive vibration-compensation masses laterally on both sides of the percussion mechanism, respectively.

German Publication DE 128 19 70 discloses formation of an axially oscillating passive vibration-compensation mass as a hollow cylinder.

According to European Publication EP 1 252 976, a passive vibration-compensating mass is arranged about the guide tube of the percussion mechanism and is displaced axially therealong.

With such passive vibration-compensating masses, it is important that the natural frequency of a vibration-compensation mass corresponds as much as possible to the to-be-damped vibration frequency. The natural frequency of a vibration-compensating mass depends essentially on the mass of the compensation mass and on the spring stiffness.

An object of the present invention is a vibration-compensating mass for a hand-held power tool and which can be produced in a large quantity with narrow tolerances with regard to its natural frequency.

Another object of the invention is to provide for a technologically easy manufacturing of different compensation masses with a different mass amount for vibration-compensating masses for different models of hand-held power tools.

### SUMMARY OF THE INVENTION

These and other objects of the present invention, which will become apparent hereinafter, are achieved by providing a hand-held power tool in which a vibration-compensating mass is secured on an inwardly located housing (e.g., on a cover housing of a gear unit) or an outwardly located (e.g., outer) housing and has at least one rigid compensation mass oscillating along an oscillation axis and formed of a plurality of fixedly connected with each other mass components, and at least one spring that axially resiliently supports the at least one compensation mass relative to the housing.

By forming the compensation mass as a rigid compensation mass of a plurality of mass components, it becomes possible to form different compensation masses (for different models of hand-held power tools) by combining a different number of mass components which themselves can be mass-produced in technologically simple manner in large quantities, with narrow tolerances.

Advantageously, the mass component has an adjustment bore, whereby a technologically simple adjustment of the mass of the mass component over the bore diameter can be effected (with an inserted in a tool, mandrel having different diameters).

Advantageously, the compensation mass is formed of a plurality of stacked mass components arranged along the oscillation axis and which are, advantageously, welded with each other using laser welding, plasma welding or inert gas arc welding. This permits to discretely adjust, by selecting the type and the number of stacked mass components, the mass of the compensation mass for vibration-compensating masses for different models of hand-held power tools.

Advantageously, the compensation mass is formed of a plurality of stacked, along the oscillation axis, identical mass components. Thereby, the mass components can be mass-produced in large quantities and are advantageously stamped of a sheet metal and then are laser-welded. This permits to produce compensation masses with narrow tolerances and in large quantities.

Alternatively, the compensation mass can be formed of two components arranged rotationally symmetrically with respect to the oscillation axis.

Thereby, the compensation mass can be formed of two, identical, diametrically oriented, mass components.

Advantageously, the two, diametrically oriented mass components are welded to each other by spot welding. Thereby, they can be assembled in a technologically simple manner.

Advantageously, the mass components are formed of two identical shell-shaped mass components. Thereby, they can be formed, using deformation process, in large quantity.

Alternatively, advantageously, the shell-shaped mass components can be partially formed as a sheet metal flexural components, which permits to mass-produce these mass components in a technologically simple manner and with narrow tolerances.

In both cases, the deformed/embossed stop surfaces for springs are formed in a mass component with a high precision.

Advantageously, the at least one spring is completely arranged, with respect to its axial length, within the compensation mass. Thereby, the entire length of the vibration-compensation mass is essentially determined by the length of the compensation mass. Because the compensation mass can be made as large as possible with respect to a vibration-compensation mass, at a strictly predetermined length of a vibration-compensating mass and spring constant, a smallest possible resonance frequency is achieved.

Advantageously, the at least one spring is located in a pocket-shaped, prismatic recess formed in the compensation mass, whereby it is force-guided, at least partially, in the recess, so that at a compression pulsating stress, it cannot swivel or break off in a transverse direction.

Advantageously, the at least one spring, at both end sides, is arranged around respective stop mandrels. Advantageously, the mandrels are sleeve-shaped. Thereby, the spring, being displaced in opposite directions on the mandrel fixedly secured on the housing, is compressively prestressed, which permits an axially limited oscillation of the compensation mass.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiments, when read with reference to the accompanying drawings.

### BRIEF DESCRIPTION OF THE DRAWINGS

The drawings show:

FIG. 1 a front elevational view of a hand-held power tool according to the present invention;

FIG. 2a a perspective view of a vibration compensation mass (in a non-vibratable, non-mounted condition) of the power tool according to FIG. 1;

FIG. 2b a cross-sectional view along line IIb-IIb in FIG. 2a;

FIG. 3 a perspective view of another embodiment of a vibration compensation mass of the power tool according to FIG. 1; and

FIG. 4 a perspective view of a further embodiment of a vibration compensation mass of the power tool according to FIG. 1.

### DETAILED DESCRIPTION OF THE PREFERRED EMBODIMENTS

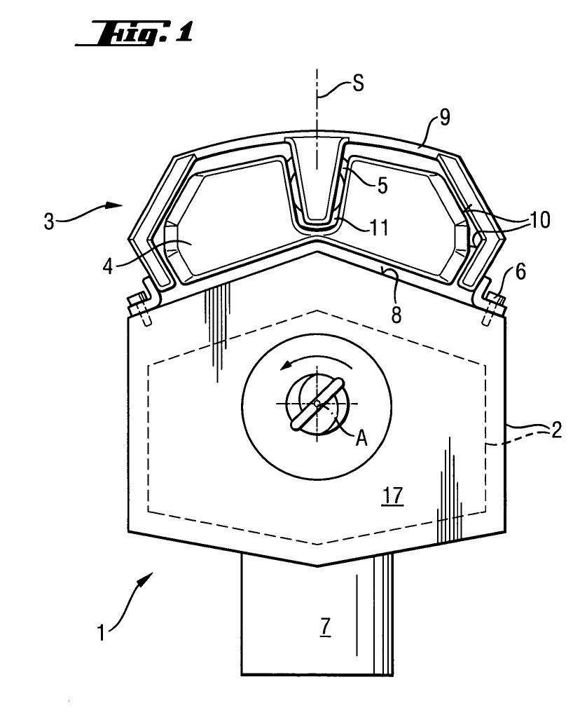

A percussion-rotary hand-held power tool, which applies axial blows along a percussion axis A and which is shown in FIG. 1, includes a vibration-compensating mass 3 that is secured on a housing 2 oscillating along the percussion axis A (shown as an outer housing, and is likewise secured on a vibration-isolated inner housing, shown with dash lines, of a percussion mechanism 17). The vibration-compensating mass 3 has a vibrating compensation mass 4 which is axially resiliently supported by a spring 5 against the outer housing 2. The vibration-compensating mass 3, which is formed mirror-symmetrically with respect to a mirror plane S in which the percussion axis A is located, is formlockingly secured on the housing 2 with fixing means 6 in form of screws. The vibration compensation mass 3 is secured on convex housing side 8 opposite the handle 7.

A correspondingly formed, concave rigid compensation mass 4 is arranged within a housing 9 of the vibration-compensation mass 3. The housing 9 surrounds, in the plane of the drawing perpendicular to the percussion axis A, the major part of the compensation mass 4 (up to the sector adjacent to the housing side 8). The compensation mass 4 is axially displaceable relative to the housing 9 over guide surfaces 10 extending along the percussion axis A which defines the oscillation axis. A single spring 5 is located in a prismatic, pocket-shaped, in the plane of the drawing perpendicular to the percussion axis A, recess 11 of the compensation mass 4.

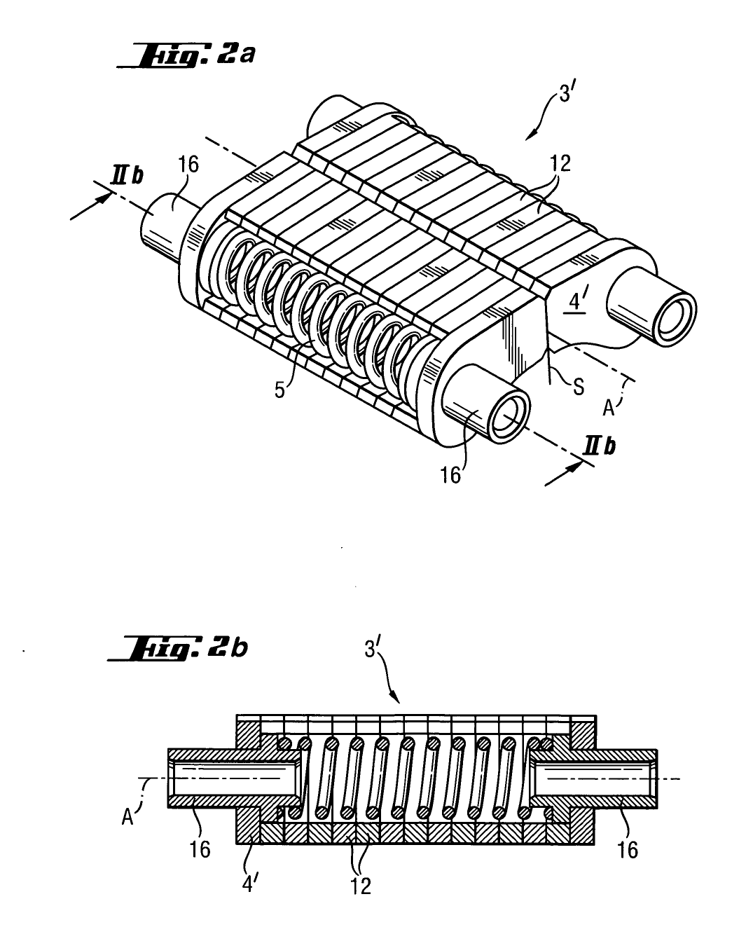

According to FIGS. 2a, 2b, an embodiment of a vibration-compensating mass 3′ is formed of a plurality of stacked and identical (up to both end sides) mass components 12 which form a rigid compensation mass 4′. The mass components 12 are welded with each other one after another along the percussion axis A. The two springs 5 are arranged, with respect to their length, completely within the compensation mass 4′ which is formed mirror-symmetrically with respect to the mirror plane S in which the percussion axis A lies. The spring 5 have their opposite end sides arranged around sleeve-shaped stop mandrels 16, respectively, which are secured on the housing 2 (FIG. 1). In the mounted condition, not shown, the axially pressed stop mandrels 16 are secured on the housing 2 (FIG. 1), with the compensation mass 4′ oscillating axially relative to the stop mandrels 16 and the housing 2 (FIG. 1).

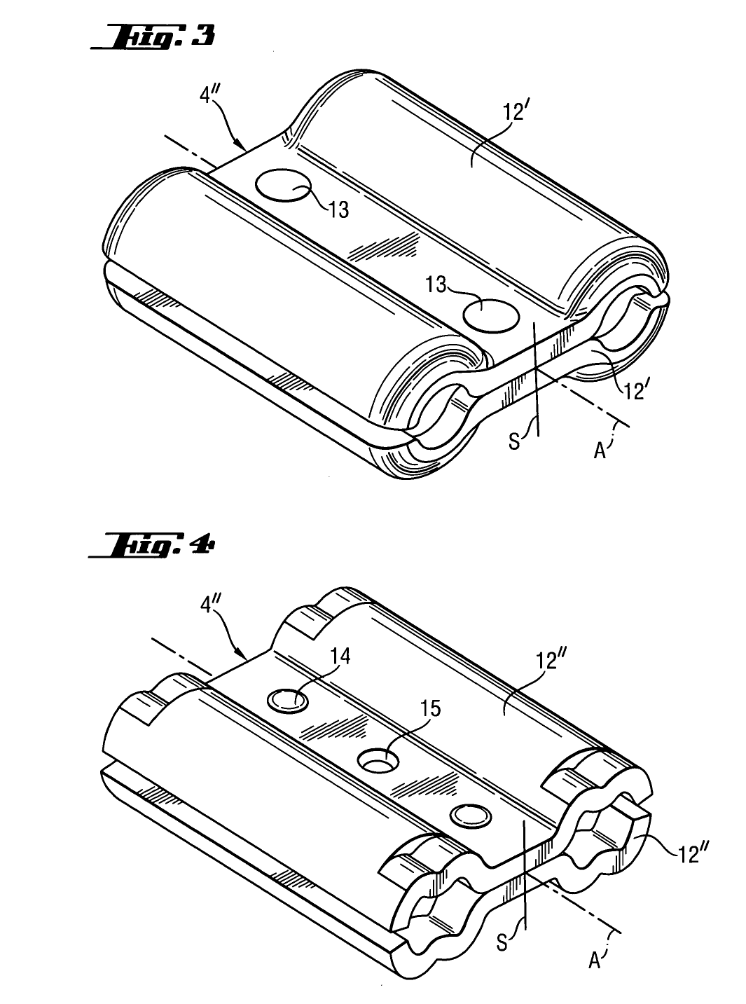

According to FIGS. 3 and 4, the compensation mass 4″ which is formed mirror-symmetrically with respect to the mirror plane A, is formed as a two-part rotationally symmetrically element. According to FIG. 3, the compensation mass 4″ is formed of two, diametrically oriented, identical mass components 12′ which are spot-welded with each other at weld spots 13. According to FIG. 4, two, diametrically oriented, identical mass components 12″ are formed as shell-shaped flexural components of sheet metal which are riveted with each other with rivets 14. The mass components 12″ also have an adjustment bore 15.

Though the present invention was shown and described with references to the preferred embodiments, such are merely illustrative of the present invention and are not to be construed as a limitation thereof and various modifications of the present invention will be apparent to those skilled in the art. It is therefore not intended that the present invention be limited to the disclosed embodiments or details thereof, and the present invention includes all variations and/or alternative embodiments within the spirit and scope of the present invention as defined by the appended claims.

What is claimed is:

1. A hand-held power tool, comprising a housing (2); a vibration-compensating mass (3, 3′) secured on the housing and having at least one rigid compensation mass (4, 4′, 4″) oscillating along an oscillation axis (A) and formed of a plurality of fixedly connected with each other mass components (12, 12′, 12″); and at least one spring (5) for axially resiliently supporting the at least one compensation mass (4, 4′) relative to the housing (2).

2. A hand-held power tool according to claim 1, wherein a mass component (12′) has an adjustment bore (15).

3. A hand-held power tool according to claim 1, wherein the fixedly connected with each other, mass components (12) comprise a plurality of stacked mass components arranged along the oscillation axis (A).

4. A hand-held power tool according to claim 3, wherein the mass components (12) are identical.

5. A hand-held power tool according to claim 1, wherein the compensation mass (4″) is formed of two components arranged rotationally symmetrically with respect to the oscillation axis (A).

6. A hand-held power tool according to claim 5, wherein the two components are diametrically oriented mass components (12′) spot-welded with each other.

7. A hand-held power tool according to claim 5, wherein the mass components (12′, 12″) are formed as shell-shaped deformed elements.

8. A hand-held power tool according to claim 5, wherein the mass components (12″) are formed as shell-shaped flexural components of sheet metal.

9. A hand-held power tool according to claim 1, wherein the at least one spring (5) is completely arranged, with respect to an axial length thereof, within the compensation mass (4, 4′, 4″).

10. A hand-held power tool according to claim 9, wherein the at least one spring (5) is located in a pocket-shaped, prismatic recess (11) formed in the compensation mass (4, 4′, 4″).

11. A hand-held power tool according to claim 1, wherein the at least one spring (5) at both end sides thereof, is arranged around respective stop mandrels.
